(19) United States
(12) Patent Application Publication
(10) Pub. No.: US 2018/0284840 A1
(43) Pub. Date: Oct. 4, 2018

(54) PROTECTIVE CASE FOR AN ELECTRONIC COMMUNICATION DEVICE

(71) Applicant: Thomas Guy, III, Brooklyn, NY (US)

(72) Inventor: Thomas Guy, III, Brooklyn, NY (US)

(73) Assignee: Thomas Guy, III, Brooklyn, NY (US)

(21) Appl. No.: 15/474,347

(22) Filed: Mar. 30, 2017

(51) Int. Cl. G06F 1/16; H04N 5/232

(52) U.S. Cl. CPC G06F 1/1626; G06F 1/1684; H04N 5/23296; G06F 1/1616; G06F 1/1643

(57) ABSTRACT

A protective case for electronic communication device includes front panel, rear panel, and opening portion. The front panel includes switching unit which receives command from user through pressing mechanism. The rear panel having plurality of side portions. The rear panel includes optical lens unit, memory unit, audio unit, display screen, and USB port. The optical lens unit captures images/video on receiving command from switching unit. The optical lens unit is rotatable and enables user to manually control the rotation direction. The audio unit enhances sound released from the electronic communication device. The memory unit integrated with the side portion to store the captured images, and videos. The display screen receives touch gesture and further displays multimedia files. The USB port integrated with the side portion to power switching unit, optical lens unit, and display screen. The opening portion joins the front panel and rear panel to receive electronic communication device.

### TECHNICAL FIELD

The present invention is generally related to an electronic communication device, particularly to a protective case for an electronic communication device.

### BACKGROUND

Portable electronic devices such as mobile phone, laptop, tablet, or phablet have components that may break or become damaged easily. These portable electronic devices are fragile and carry valuable personal information. As a result, people use protective case or cover to protect their electronic devices. A reliable protective case protects the electronic device from dust, scratches and liquids. These protective cases are available in various shapes and sizes. Depending on the particular case design, these protective cases protect the back, side, and front of the devices from scratches, dings, drops, and other physical damage.

However, the aforementioned protective cases do not provide any touch screen display which can receive the touch gesture as well as displays the multimedia files such images and videos. Some protective cases include just a protective transparent cover, but are not waterproof. Further these protective cases are not designed in such a way that it may receive the power wirelessly and charge the elements integrated with the protective case. Therefore, there is a need of a protective case that overcomes from the aforementioned problem in the prior art and further enables the user to capture images from the inbuilt camera and receive touch gesture without removing the protective case from the electronic communication devices.

Further limitations and disadvantages of conventional and traditional approaches will become apparent to one of skill in the art through comparison of described systems with some aspects of the present disclosure, as set forth in the remainder of the present application and with reference to the drawings.

### SUMMARY OF THE INVENTION

A protective case for an electronic communication device is provided substantially, as shown in and/or described in connection with at least one of the figures, as set forth more completely in the claims.

According to the embodiments illustrated herein, a protective case for an electronic communication device is provided. The protective case includes a front panel, a rear panel, and an opening portion. The front panel includes a switching unit. The switching unit receives command from a user through a pressing mechanism. The rear panel having plurality of side portions. The rear panel includes an optical lens unit, a memory unit, an audio unit, a display screen, and a USB port.

The optical lens unit captures images or video on receiving the command from the switching unit. In an embodiment, the optical lens unit is rotatable and enable the user to manually control the rotation direction. The memory unit integrated with the side portion to store the captured images, and videos. The audio unit to enhance sound released from the electronic communication device. The display screen receives touch gesture from a user and further displays one or more multimedia files such as images or video clips stored in the memory unit. The USB port integrated with the side portion to power the switching unit, the optical lens unit, and the display screen. The opening portion joins the front panel and the rear panel to receive the electronic communication device.

These features and advantages of the present disclosure may be appreciated by reviewing the following description of the present disclosure, along with the accompanying figures wherein like reference numerals refer to like parts.

### BRIEF DESCRIPTION OF DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates the front panel of the protective case for an electronic communication device, in accordance with at least one embodiment;

FIG. 2 illustrates the rear panel of the protective case for an electronic communication device, in accordance with at least one embodiment;

FIG. 3 illustrates a side portion of the protective case for an electronic communication device, in accordance with at least one embodiment;

FIG. 4 illustrates an exemplary view of the front panel of the protective case for a laptop, in accordance with at least one embodiment;

FIG. 5 illustrates the exemplary view of the rear panel of the protective case for the laptop, in accordance with at least one embodiment; and

FIG. 6 illustrates the exemplary view of the side portion of the protective case for the laptop, in accordance with at least one embodiment.

### DETAILED DESCRIPTION

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment”, “at least one embodiment”, “an embodiment”, “one example”, “an example”, “for example”, and so on indicate that the embodiment(s) or example(s) may include a particular feature, structure, characteristic, property, element, or limitation, but not every embodiment or example necessarily includes that particular feature, structure, characteristic, property, element, or limitation. Furthermore, repeated use of the phrase “in an embodiment” does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described. All publications, patents, and patent applications mentioned herein are incorporated in their entirety.

It is noted that as used herein and in the appended claims, the singular forms “a”, “and”, and “the” include plural referents, unless the context clearly dictates otherwise. In the claims, the terms “first”, “second”, and so forth are to be interpreted merely as ordinal designations; they shall not be limited in themselves. Furthermore, the use of exclusive terminology such as “solely”, “only”, and the like in connection with the recitation of any claim element is contemplated. It is also contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

All references cited herein, including publications, patent applications, and patents, are hereby incorporated by reference to the same extent as if each reference were individually and specifically indicated to be incorporated by reference, and were set forth in its entirety herein.

The recitation of ranges of values herein is merely intended to serve as a shorthand method of referring individually to each separate value falling within the range, unless otherwise indicated herein, and each separate value is incorporated into the specification as if it were individually recited herein.

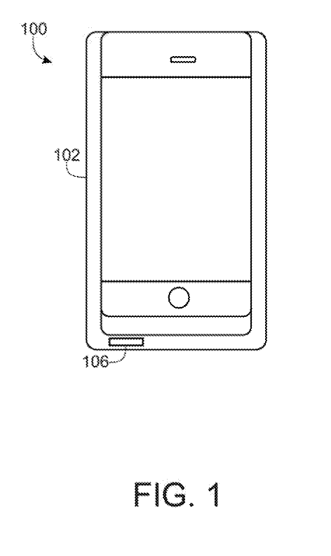

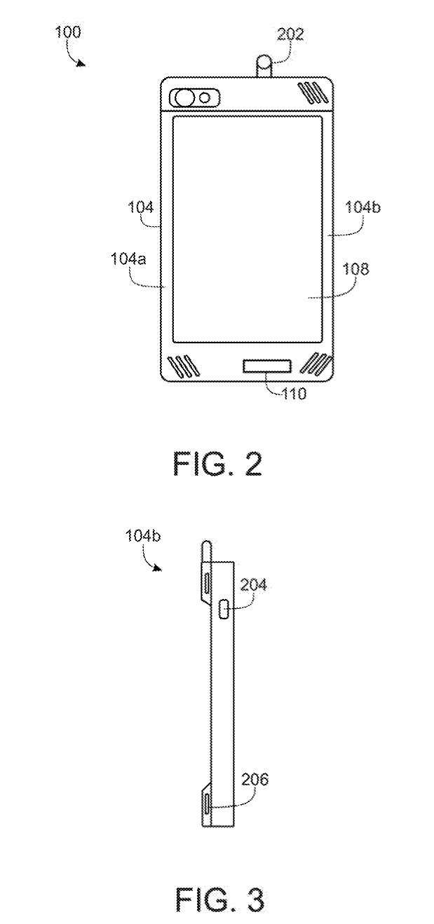

FIG. 1 illustrates the front panel 102 of the protective case 100 for an electronic communication device, in accordance with at least one embodiment. FIG. 2 illustrates the rear panel 104 of the protective case 100 for an electronic communication device, in accordance with at least one embodiment. FIG. 2 is explained in conjunction with FIG. 1. The protective case 100 includes a front panel 102, a rear panel 104 (shown in FIG. 2), and an opening portion (not shown in Figs.). Examples of the electronic communication device may include, but are not limited to, a personal computer, a laptop, a personal digital assistant (PDA), a mobile device, a tablet, or any other electronic communication device. The design and the sizes of the present protective case 100 is customized as per the various aforementioned electronic communication devices.

The front panel 102 includes a switching unit 106. The switching unit 106 receives command from a user through a pressing mechanism. Examples of the switching unit 106 includes a physical button or touch portion to receive press gesture from the user. The rear panel 104 (shown in FIG. 2) having plurality of side portions 104a (explained in conjunction with FIG. 3), and 104b (explained in conjunction with FIG. 3). The rear panel 104 includes an optical lens unit 202, a memory unit 204 (shown and explained in conjunction with FIG. 3), an audio unit 110, a display screen 108, and a USB port 206 (shown and explained in conjunction with FIG. 3). The optical lens unit 202 pop-up to captures images or video on receiving the command from the switching unit 106. In an embodiment, the optical lens unit 202 is rotatable and enables the user to manually control the rotation direction. The pop-up mechanism enables the optical lens unit 202 to appear out of the protective case 100 on receiving the press gesture of the user.

The audio unit 110 enhances the sound released from the electronic communication device. The display screen 108 receives touch gesture from a user, and further displays one or more multimedia files such as images or video clips stored in the memory unit 204 (shown and explained in conjunction with in FIG. 3). The present protective case 100 allows user to use the touch display of the electronic communication device without removing the protective case 100.

FIG. 3 illustrates a side portion 104a of the protective case 100 for an electronic communication device, in accordance with at least one embodiment. FIG. 3 is explained in conjunction with FIG. 1 and FIG. 2. The memory unit 204 integrated with the side portion 104b to store the captured images, and videos. Example of the memory unit 204 includes but not limited to a slot to receive memory cards such as SD card or micro SD card. The USB port 206 integrated with the side portion 104b to power the switching unit 106, the optical lens unit 202, and the display screen 108. The USB port 206 may utilize USB wire cable to power (charge) the switching unit 106, the optical lens unit 202, and the display screen 108. The opening portion joins the front panel 102 and the rear panel 104 to receive the electronic communication device.

The protective case 100 further includes a wireless charging mechanism, and a wireless unit. The wireless charging mechanism wirelessly powers the elements of the protective case 100 such as the switching unit 106, the optical lens unit 202, and the display screen 108. Thus the protective case 100 gets charge without the use of a physical connection by utilizing the magnetic resonance, or inductive power transfer. The magnetic resonance, or inductive power transfer is the process of transferring an electrical current in between the power transmitting source and the protective case through the use of coils to induce the electromagnetic field. The wireless unit communicates with an external electronic communication device to transmit or receive a multimedia file. Further the present protective case 100 is waterproof to prevent the electronic communication device from the water.

The wireless unit includes various wireless communication protocols. Examples of such wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, Bluetooth, infrared (IR), IEEE 802.11, 802.16, 2G, 3G, 4G cellular communication protocols, and/or Bluetooth (BT) communication protocols.

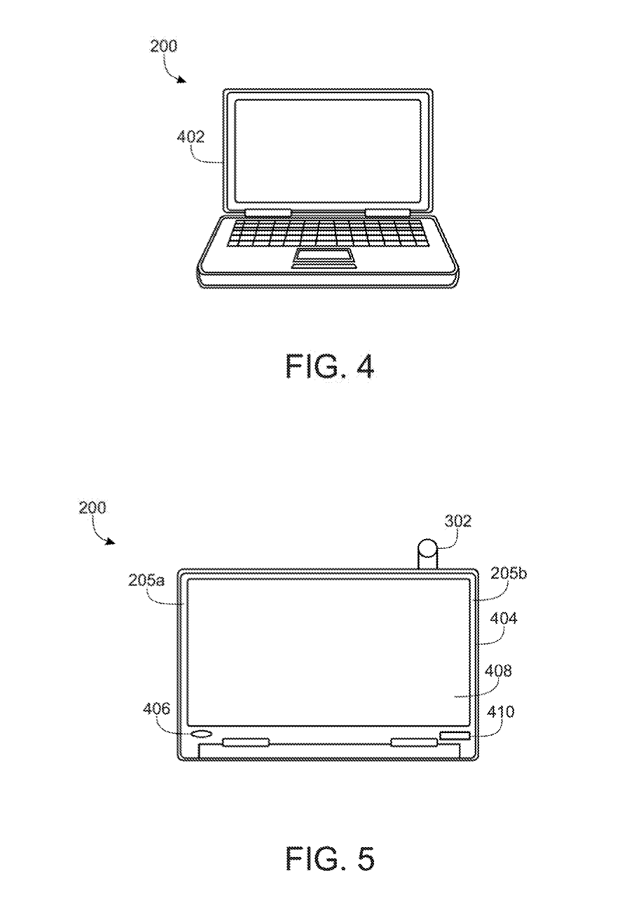

FIG. 4 illustrates an exemplary view 200 of the front panel 402 of the protective case for a laptop, in accordance with at least one embodiment. FIG. 4 is explained in conjunction with FIG. 1 and FIG. 2. FIG. 5 illustrates the exemplary view 200 of the rear panel 404 of the protective case for the laptop, in accordance with at least one embodiment. FIG. 5 is explained in conjunction with FIG. 4. As mentioned above, the design and the sizes of the present protective case 100 is customized as per the various aforementioned electronic communication devices. FIGS. 4-6 discuss the present protective case 100 in the context of the laptop.

The exemplary view 200 of the protective case 100 includes a front panel 402, a rear panel 404 (shown in FIG. 5), and an opening portion (not shown in Figs.). The exemplary view 200 explains about the protective case 100 used for the laptop. The front panel 402 includes a switching unit 406. The switching unit 406 receives command from a user through a pressing mechanism.

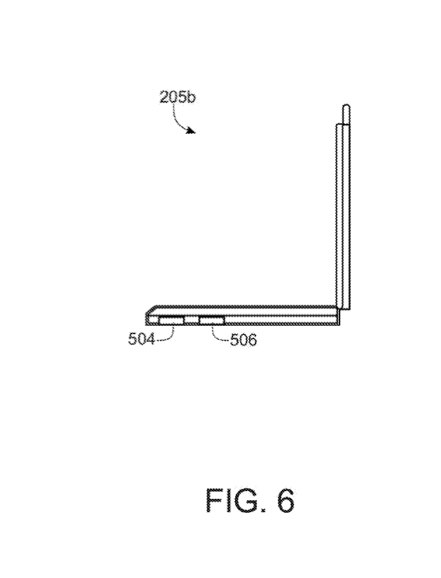

The rear panel 404 (shown in FIG. 5) having plurality of side portions 205a (explained in conjunction with FIG. 6), and 205b (explained in conjunction with FIG. 6). The rear panel 404 includes an optical lens unit 302, a memory unit 504 (shown and explained in conjunction with FIG. 6), an audio unit 410, a display screen 408, and a USB port 506 (shown and explained in conjunction with FIG. 6). The optical lens unit 302 pop-up to captures images or video on receiving the command from the switching unit 406. In an embodiment, the optical lens unit 302 is rotatable and enables the user to manually control the rotation direction. The pop-up mechanism enables the optical lens unit 302 to appear out of the protective case 100 on receiving the press gesture of the user. The audio unit 410 (shown in FIG. 5) enhances the sound released from the laptop. The display screen 408 receives the touch gesture from a user and further displays one or more multimedia files such as images or video clips stored in the memory unit 204 (shown and explained in conjunction with in FIG. 6). The present protective case 100 allows user to use the touch display of the laptop without removing the protective case 100.

FIG. 6 illustrates the exemplary view of the side portion 205b of the protective case 100 for the laptop, in accordance with at least one embodiment. FIG. 6 is explained in conjunction with FIG. 4. The memory unit 504 integrated with the side portion 205b to store the captured images, and videos. Example of the memory unit 504 includes but not limited to SD card. The USB port 506 integrated with the side portion 205b to power the switching unit 406, the optical lens unit 302, and the display screen 408. The USB port 506 may utilize USB wire cable to power (charge) the switching unit 406, the optical lens unit 302, and the display screen 408. The opening portion joins the front panel 402 and the rear panel 404 to receive the laptop. Thus the present protective case 100 enables the user to capture images from the inbuilt camera and receive touch gesture without removing the protective case 100.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the appended claims. Thus, it is intended that the present invention cover the modifications and variations of this invention, provided they are within the scope of the appended claims and their equivalents.

1: A protective case for an electronic communication device, the protective case comprising:
a front panel includes a switching unit to receive command from a user through a pressing mechanism; and
a rear panel having plurality of side portions, the rear panel includes:
an optical lens unit to capture images or video on receiving the command from the switching unit, wherein the optical lens unit is rotatable and enable the user to manually control the rotation direction;
an audio unit to enhance sound released from the electronic communication device;
a display screen to receive touch gesture from a user and further displays one or more multimedia files;
a memory unit integrated with the side portion to store the captured images, and videos; and
a USB port integrated with the side portion to power the switching unit, the optical lens unit, and the display screen; and
an opening portion to join the front panel and the rear panel to receive the electronic communication device.

2: The protective case according to claim 1 further includes a wireless charging mechanism in order to wirelessly power the switching unit, the optical lens unit, and the display screen.

3: The protective case according to claim 1 further includes a wireless unit to communicate with an external electronic communication device to transmit or receive a multimedia file.

4: The protective case according to claim 1 is waterproof to prevent the electronic communication device from the water.
